(19) United States
(12) Patent Application Publication
(10) Pub. No.: US 2008/0133502 A1
(43) Pub. Date: Jun. 5, 2008

(54) System and method for utilizing multiple values of a search criteria

(76) Inventors: Elena Gurevich, Bad Schoenborn (DE); Paola Sala, Heidelberg (DE); Giovanni Deledda, Rauenberg (DE); Andrei Jadanovski, Schwaebisch Hall (DE); Hermann Resch, Heidelberg (DE); Hua Wang, Meckesheim (DE)

Correspondence Address: FISH & RICHARDSON, P.C., PO BOX 1022, MINNEAPOLIS, MN, 55440-1022, US

(21) Appl. No.: 11/607,264

(22) Filed: Dec. 1, 2006

(51) Int. Cl. G06F 17/30

(52) U.S. Cl. 707/5; 707/E17.14

(57) ABSTRACT

A method and system utilizing one or more search terms corresponding to a search criteria is operable to search one or more data repositories of one or more modules. According to one implementation, one or more search strings may be inputted in a search screen. Each search string may correspond to a separate search criteria and may include one or more search terms. The search terms may be utilized to form a search table. A multiple value screen may be selectable from the search screen. The search terms are used to populate the one or more fields provided on the multiple value screen. The search terms may be added to, modified, or deleted in the multiple value screen. The search screen may be selectable from the multiple value screen, and any modification, deletion, or addition of the search terms may be updated in the search table and the search string.

### TECHNICAL FIELD

This disclosure relates generally to data processing and, more particularly, to methods, systems, and software utilizing multiple values for one or more search criteria to search one or more data repositories, separately or simultaneously, and identify any data corresponding to the defined search.

### BACKGROUND

Utilizing a single search criteria value or term to identify related data contained in a data repository, such as a database, is known. However, such methods are ineffective and/or inefficient to search and identify a plurality of data corresponding to different search criteria values or a range of search criteria values in a single search operation. Consequently, a new, different search must be run for each search criteria value of a collection of search criteria values. Performing a search for each search criteria value is time consuming, costly due to the time required to input and process each search separately, and requires additional work once all of the individual searches have been conducted, such as to consolidate the results of the individual search criteria.

### SUMMARY

A method and system to utilize one or more search terms corresponding to a search criteria is operable to search one or more data repositories of one or more modules or applications that may be unrelated. According to one example implementation, one or more search strings may be input in a search screen or interface by a user. Each search string may correspond to a separate search criteria and may include one or more search terms. Software may define a search table with the search terms. A multiple value screen may be selectable from the search screen. Software may populate the one or more fields provided on the multiple search screen with the search terms of the search string. A user may modify the search terms, such as by adding to, deleting, or otherwise changing the search terms in the multiple value screen. The search screen may be selectable from the multiple value screen, and the software updates the search table and the search string with any modification, deletion, or addition made to the search terms.

The method and system of the present disclosure may be generic and, therefore, applicable to search data repositories of different modules simultaneously or at different times. According to one or more implementations, the multiple value search techniques of the present disclosure can be generic such that it is operable with multiple, potentially disparate, modules. Thus, the multiple value search method and system is operable to search data of multiple modules simultaneously or at different times with a defined search having one or more multiple value search criteria. For example, the present system is able to search one or more data repositories of separate modules with all of the defined search strings of a defined search or utilize only a portion of the search strings to search one module and only a portion of the search strings to search a separate module. Alternately, all of the search strings may be utilized in searching the data of one or more modules while only a portion of the search strings may be utilized in searching the data of a separate module or modules. The output of such a search may be consolidated into a single search report or may be classified by the data type or module from which the data was retrieved. However, the search report may be organized in any fashion.

The system and method of the present disclosure may also include an analysis functionality to aid the user in identifying an unrecognized or rejected search term. When an unrecognized term is encountered, the analysis functionality may determine a reason for an error or null set and present a message to the user identifying the problem. Such a message aids the user in quickly determining the reasons for the error. Therefore, according to one implementation, the analysis functionality is operable to analyze an input search term, compare the input search term with an expected search term type, and provide information to the user as to why the inputted term and the expected term type do not correspond. Moreover, the analysis functionality may be dynamic. That is, the analysis functionality may analyze the search terms of a particular criteria field as the terms are being inputted by a user to determine whether the one or more search terms are compatible with the data type corresponding to the search criteria. The analysis functionality may also be customizable or otherwise capable of automatically determining the type of expected input for a particular search criteria. Further, the analysis functionality may also inform a user of which search criteria is utilized to search the data of a particular module. As a result, the analysis functionality may display or otherwise identify to the user which search criteria was used to search the data repositories of a particular module.

The details of these and other aspects and embodiments of the disclosure are set forth in the accompanying drawings and the description below. For example, each of the foregoing example methods and techniques, as well as others disclosed, may be computer implementable. Moreover, some or all of these aspects may be further included in respective systems and software for utilizing one or more search terms corresponding to search criteria to search one or more data repositories, either separately or simultaneously. Certain features, objects, and advantages of the various embodiments will be apparent from the description, drawings, and the claims.

### DESCRIPTION OF DRAWINGS

FIG. 1 illustrates an example system for defining and conducting multiple term criteria searches in accordance with one implementation of the present disclosure;

FIG. 2 illustrates an example application implementing certain techniques and components in accordance with one embodiment of the present disclosure;

FIG. 3 is an example search GUI for inputting search strings to define a search according to an implementation of the system in FIG. 1;

FIG. 4 is an example multiple value GUI for adding, deleting, or otherwise modifying search terms according to an implementation of the system in FIG. 1;

FIG. 5 is the GUI of FIG. 3 reflecting modifications made to the defined search according to an implementation of the present disclosure;

FIGS. 6A and 6B illustrate an example search table according to an implementation of the present disclosure, wherein FIG. 6A represents an example search table corresponding to the search GUI of FIG. 3 and FIG. 6B represents an example search table corresponding to the search GUI of FIG. 5;

FIG. 7 is a flowchart illustrating functionality for switching between the search GUI of FIG. 3 and the multiple value GUI of FIG. 4, according to an implementation of the present disclosure; and

FIG. 8 is a flow diagram illustrating an operating method, according to an implementation of the present disclosure.

### DETAILED DESCRIPTION

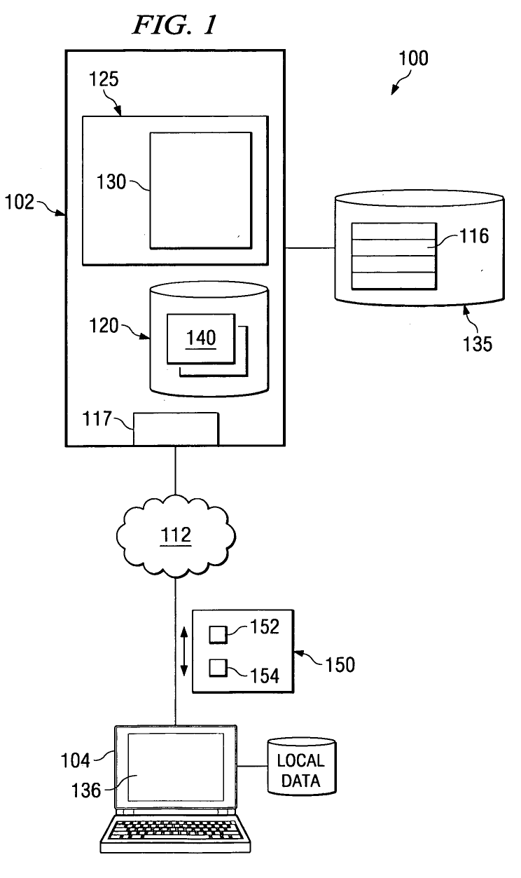

The disclosure provides systems and methods for utilizing multiple values for one or more search criteria to search one or more data repositories and identify any data corresponding to the defined search. FIG. 1 illustrates an example system 100 for searching one or more data repositories utilizing one or more search criteria. System 100 may perform a search utilizing one or more search criteria, wherein multiple search terms may be used for each search criteria. The system 100 may utilize a method for using multiple values of a search criteria. According to the method, the system 100 may receive a search string corresponding to at least one search criteria via a search interface, wherein the search string comprises one or more search terms. The system 100 may generate a search table for one or more search criteria based on the one or more search terms and perform a search of at least one data repository using the search table. Additionally, the system 100 may return at least a portion of the search results satisfying the search terms to the search interface. The system 100 allows a user to utilize a single search having multiple search terms for a single search criteria. As a result, system 100 reduces the number of searches that must be performed to identify information corresponding to designated search terms. Further, system 100 may be connected to multiple modules that may be unrelated and search each module's data and return results corresponding to the defined search terms.

System 100 may be a distributed client/server system that spans one or more networks, such as network 112. In such implementations, data may be communicated or stored in an encrypted format using any standard or proprietary encryption algorithm. But system 100 may be in a dedicated enterprise environment—across a local area network or subnet—or any other suitable environment without departing from the scope of this disclosure. The system 100 may include or be communicably coupled with a server 102, one or more clients 104, and network 112.

Server 102 comprises an electronic computing device operable to receive, transmit, process, and store data associated with system 100. Generally, FIG. 1 provides merely one example of computers that may be used with the disclosure. Each computer is generally intended to encompass any suitable processing device. For example, although FIG. 1 illustrates one server 102 that may be used with the disclosure, system 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UNIX, Windows Server, or any other suitable operating system. According to one embodiment, server 102 may also include or be communicably coupled with a web server and/or a mail server.

As illustrated (but not required), server 102 is communicably coupled with a relatively remote repository 135 over a portion of network 112. Repository 135 is any intra-enterprise, inter-enterprise, regional, nationwide, or substantially national electronic storage facility, data processing center, or archive that allows for one or a plurality of registration processors to dynamically store data 116, which may include any data related to, used, created, stored by, or otherwise associated with an application. Repository 135 may be searchable utilizing the systems and methods of the present disclosure. Repository 135 may be a central database communicably coupled with one or more servers 102 and clients 104 via a virtual private network (VPN), SSH (Secure Shell) tunnel, or other secure network connection. Repository 135 may be physically or logically located at any appropriate location so long as the repository 135 remains operable to store information and/or data associated with system 100 and communicate such information and/or data to server 102 or at least a subset of plurality of clients 104.

As a possible supplement to or replacement of repository 135, illustrated server 102 may include local memory 120. Memory 120 may include any memory or database module and may take the form of volatile or non-volatile memory including, without limitation, magnetic media, optical media, random access memory (RAM), read-only memory (ROM), removable media, or any other suitable local or remote memory component. Illustrated memory 120 may include application data 140 for one or more applications, as well as data involving VPN applications or services, firewall policies, a security or access log, print or other reporting files, HTML files or templates, related or unrelated software applications or sub-systems, and others. Consequently, memory 120 may also be considered a repository of data, such as a local data repository from one or more applications.

Application data 140 may include data associated with one or more business applications or modules. This application data 140 may be organized into business objects or include global data types that span applications. For example, the application data 140 may include purchase order numbers, invoice numbers or identifiers, invoice names, order status identifiers, product descriptions, product names or identifiers, vendor product numbers or identifiers, product categories, vendor names or identifiers, requesting party names or identifiers, product recipient names or identifiers, delivery locations, account numbers, account assignment categories, account assignment values, invoice recipient names or identifiers, invoicing parties, gross invoice values, gross invoice amounts, and invoice dates. In some embodiments, the application data 140 (or pointers thereto) may be stored in one or more tables in a relational database described in terms of SQL statements or scripts. In another embodiment, the application data 140 may be formatted, stored, or defined as various data structures in text files, extensible Markup Language (XML) documents, Virtual Storage Access Method (VSAM) files, flat files, Btrieve files, comma-separated-value (CSV) files, internal variables, or one or more libraries. In short, the application data 140 may comprise one table or file or a plurality of tables or files stored on one computer or across a plurality of computers in any appropriate format. Indeed, some or all of the application data 140 may be local or remote without departing from the scope of this disclosure and store any type of appropriate data. Moreover, the application data 140 may be bundled and/or transmitted in a different format, than it was stored in. In short, the application data 140 may be provided or otherwise stored in one or more repositories, such as the repository 135 or the memory 120. These repositories may be centrally located and may be associated with one or more business modules that may be unrelated.

Server 102 may also include processor 125. Processor 125 executes instructions and manipulates data to perform the operations of the server 102 and may be, for example, a central processing unit (CPU), a blade, an application specific integrated circuit (ASIC), or a field-programmable gate array (FPGA). Although FIG. 1 illustrates a single processor 125 in server 102, multiple processors 125 may be used according to particular needs and reference to processor 125 is meant to include multiple processors 125 where applicable. In the illustrated embodiment, processor 125 executes application 130.

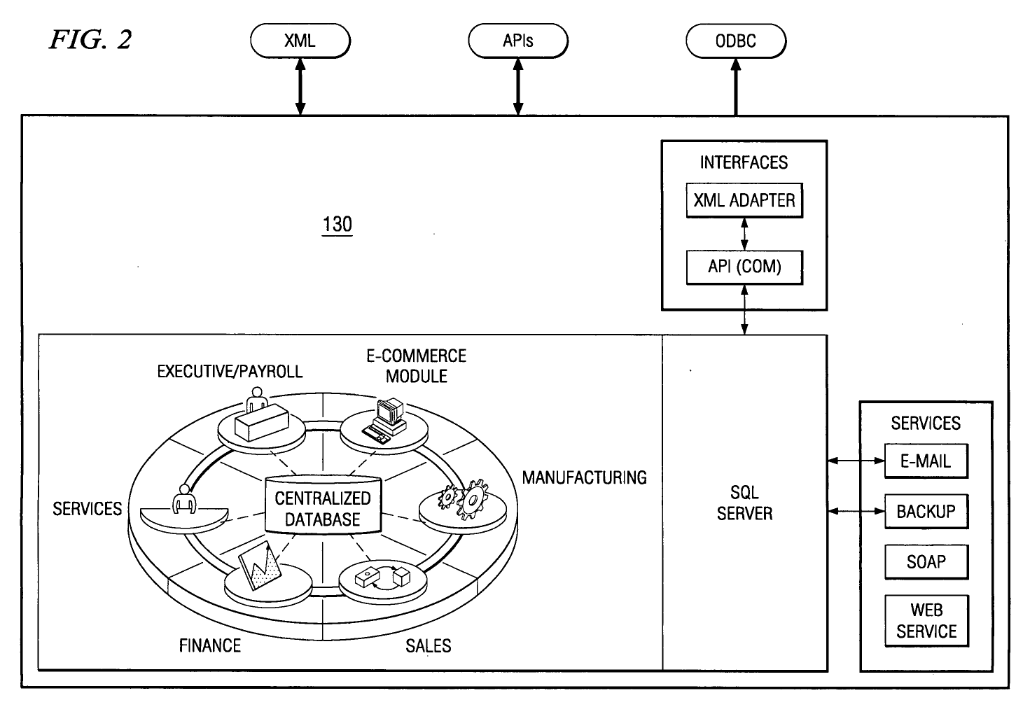

At a high, application 130 is any application, program, module, process, or other software that may utilize, change, delete, generate, or is otherwise associated with the data and/or information 140 and/or 116 that may be searchable according to the present disclosure. In certain cases, system 100 may implement a composite application 130, as described below in FIG. 2. Regardless of the particular implementation, “software” may include software, firmware, wired or programmed hardware, or any combination thereof as appropriate. Indeed, application 130 may be written or described in any appropriate computer language including C, C++, Java, Visual Basic, assembler, Perl, any suitable version of 4GL, as well as others. For example, portions of a composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET. It will be understood that, while application 130 is illustrated in FIG. 2 as including numerous sub-modules, application 130 may instead be a single multi-tasked module that implements the various features and functionality through various objects, methods, or other processes. Further, while illustrated as internal to server 102, one or more processes associated with application 130 may be stored, referenced, or executed remotely. For example, a portion of application 130 may be a web service that is remotely called, while another portion of application 130 may be an interface object bundled for processing at remote client 104. Moreover, application 130 may be a child or sub-module of another software module or enterprise application (not illustrated) without departing from the scope of this disclosure. Indeed, application 130 may be a hosted solution that allows multiple parties in different portions of the process to perform the respective processing.

More specifically, as illustrated in FIG. 2, application 130 may be a composite application, or an application built on other applications, that includes an object access layer (OAL) and a service layer. In this example, application 130 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 130 may run on a heterogeneous IT platform. In doing so, composite application may be cross-functional in that it may drive business processes across different applications, technologies, and organizations. Accordingly, composite application 130 may drive end-to-end business processes across heterogeneous systems or sub-systems. Application 130 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 130, it may instead be a standalone or (relatively) simple software program. Regardless, application 130 may also perform processing automatically, which may indicate that the appropriate processing is substantially performed by at least one component of system 100. It should be understood that automatically further contemplates any suitable administrator or other user interaction with application 130 or other components of system 100 without departing from the scope of this disclosure.

Referring again to FIG. 1, server 102 may also include interface 117 for communicating with other computer systems, such as clients 104, over network 112 in a client-server or other distributed environment. In certain embodiments, server 102 receives data from internal or external senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Network 112 facilitates wireless or wireline communication between computer server 102 and any other local or remote computer, such as clients 104. Network 112 may be all or a portion of an enterprise or secured network. In another example, network 112 may be a VPN merely between server 102 and client 104 across wireline or wireless link. Such an example wireless link may be via 802.11a, 802.11b, 802.11g, 802.20, WiMax, and many others. While illustrated as a single or continuous network, network 112 may be logically divided into various sub-nets or virtual networks without departing from the scope of this disclosure, so long as at least a portion of network 112 may facilitate communications between server 102 and at least one client 104. For example, server 102 may be communicably coupled to repository 135 through one sub-net while communicably coupled to a particular client 104 through another. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network accessible to users via certain local or remote clients 104.

Client 104 may be any computing device operable to connect or communicate with server 102 or network 112 using any communication link. At a high level, each client 104 includes or executes at least GUI 136 and comprises an electronic computing device operable to receive, transmit, process and store any appropriate data associated with system 100. It will be understood that there may be any number of clients 104 communicably coupled to server 102. Further, “client 104” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers. As used in this disclosure, client 104 is intended to encompass a personal computer, touch screen terminal, workstation, network computer, kiosk, wireless data port, smart phone, personal data assistant (PDA), one or more processors within these or other devices, or any other suitable processing device. For example, client 104 may be a PDA operable to wirelessly connect with an external or unsecured network. In another example, client 104 may comprise a laptop computer that includes an input device, such as a keypad, touch screen, mouse, or other device that can accept information, and an output device that conveys information associated with the operation of server 102 or clients 104, including digital data, visual information, or GUI 136. Both the input device and output device may include fixed or removable storage media such as a magnetic computer disk, CD-ROM, or other suitable media to both receive input from and provide output to users of clients 104 through the display, namely the client portion of GUIs or application interface 136.

GUI 136 comprises a graphical user interface operable to allow the user of client 104 to interface with at least a portion of system 100 for any suitable purpose, such as viewing application or other transaction data. Generally, GUI 136 provides the particular user with an efficient and user-friendly presentation of data provided by or communicated within system 100. GUI 136 may comprise a plurality of customizable frames or views having interactive fields, pull-down lists, and buttons operated by the user. GUI 136 may also present a plurality of portals or dashboards. For example, GUI 136 may display a secure webpage that allows users to input and define search parameters for one or more modules. It should be understood that the term graphical user interface may be used in the singular or in the plural to describe one or more graphical user interfaces and each of the displays of a particular graphical user interface. Indeed, reference to GUI 136 may indicate a reference to the front-end or a component of application 130, as well as the particular interface accessible via client 104, as appropriate, without departing from the scope of this disclosure. Therefore, GUI 136 contemplates any graphical user interface, such as a generic web browser or touch screen, that processes information in system 100 and efficiently presents the results to the user. Server 102 can accept data from client 104 via the web browser (e.g., Microsoft Internet Explorer or Netscape Navigator) and return the appropriate HTML or XML responses to the browser using network 112.

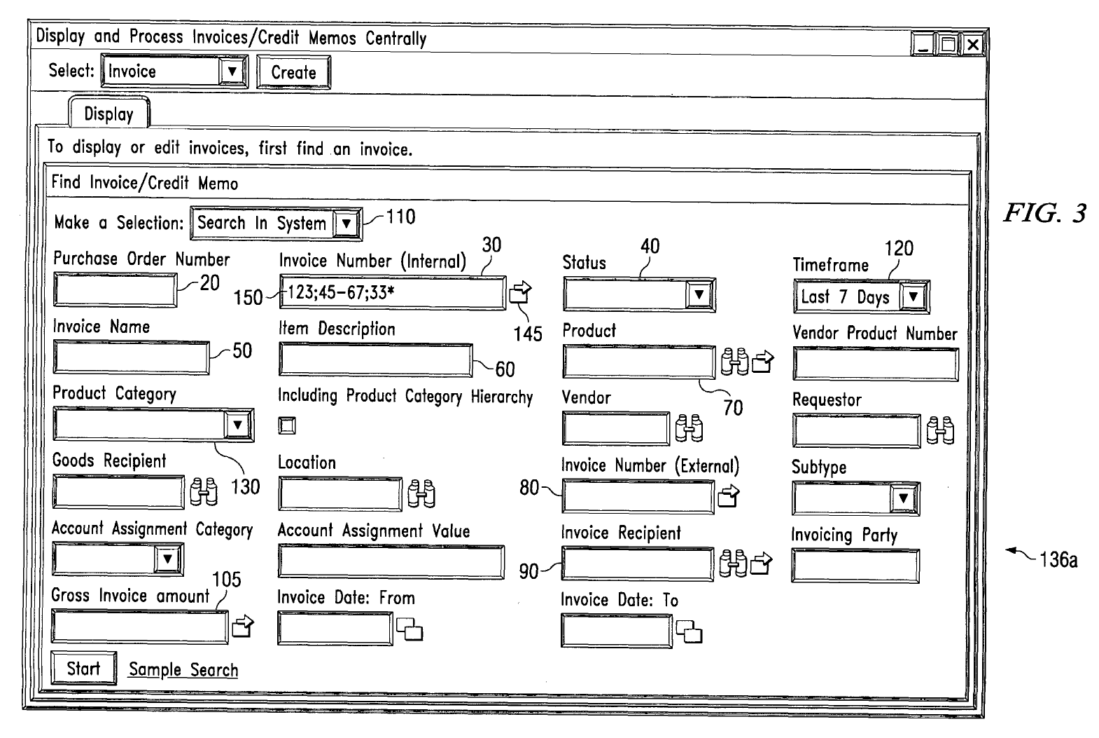

FIG. 3 illustrates the GUI 136a according to one implementation of a multiple search criteria tool for use with one or more applications. For example, the GUI 136a may relate to a business application for identifying an invoice corresponding to one or more search criteria, as well as a number of other modules implementing other business functionality. However, the multiple search criteria tool may be implemented with any application for which searching a group of data may be required or desired.

The GUI 136a (hereinafter referred to as “search screen”) may include a plurality of search criteria fields. A search string may be inputted into one or more of the search criteria fields to define a search to be conducted. A search string inputted for a particular search criteria field may include one or more search terms.

As illustrated, the search screen includes two types of search fields. Search strings entered into the first type of search field may be user-defined search strings, such as a series of alphanumeric characters, and may be entered using an input device, such as a keyboard. Examples of this type of search field include, among others, a Purchase Order Number field 20, an Invoice Number (Internal) field 30, Status field 40, Invoice Name field 50, Item Description field 60, Product field 70, Invoice Number (External) 80, Invoice Recipient field 90, and Gross Invoice Amount field 105. Examples of the second type of search field include, among others, a System Search field 110, a Timeframe field 120, and a Product Category field 130. Search strings for the second type of search field may be entered by selecting one or more values from a pull-down menu.

An arrow icon button 145 is provided adjacent to several of the search criteria fields. For example, Invoice Number (Internal) field 30, Product field 70, Invoice Number (External) 80, Invoice Recipient field 90, and Gross Invoice Amount field 105 include an arrow icon button 145 disposed adjacent thereto. The arrow icon button 145 designates search criteria fields for which multiple search values may be inputted. Although the search screen illustrates only some of the search criteria fields having the arrow icon button 145 and, therefore, capable of having multiple search values inputted therein, other implementations may include more or fewer search criteria fields capable of accepting search strings comprising multiple search values. The search string may include a single search value, a plurality of search values, and/or one or more ranges of search values. For example, the Invoice Number (Internal) field 30 includes a search string 150 including multiple search values. As shown, the search string 150 includes three parts-two search values and a ranges of values. The individual portions of the search string are separated by a designated or predetermined character. For example, FIG. 3 illustrates the use of a semicolon (;) to separate the different parts of the search string, although any other character may be used to separate the different values or range of values of the search string from each other. Further, wildcard characters may also be used with the values or range of values of the search string. For example, an asterisk (*) may be used to represent one or more characters of a search value, whereas a plus sign (+) may be used to represent only a single character. The asterisk (*) and plus sign (+) are only used as examples, and other characters may be defined to operate in the same or similar manner as the wildcard characters described above. Further, a range of values may be inputted by defining a beginning value of the search range and an end value for the search range separated by a designated character, such as a dash (−) or a tilde mark (˜), although any other character may be used.

As shown in the illustrated example, the search string 150 is defined to return any and all entries contained in data repository, corresponding to the Invoice Number (Internal) field 30 represented by the number, “123,” a range of entries corresponding to 45 and 67, inclusive, and any entry beginning with the number “33.” The arrow icon button 145 may be selected with or without a search string being entered in the corresponding search criteria field.

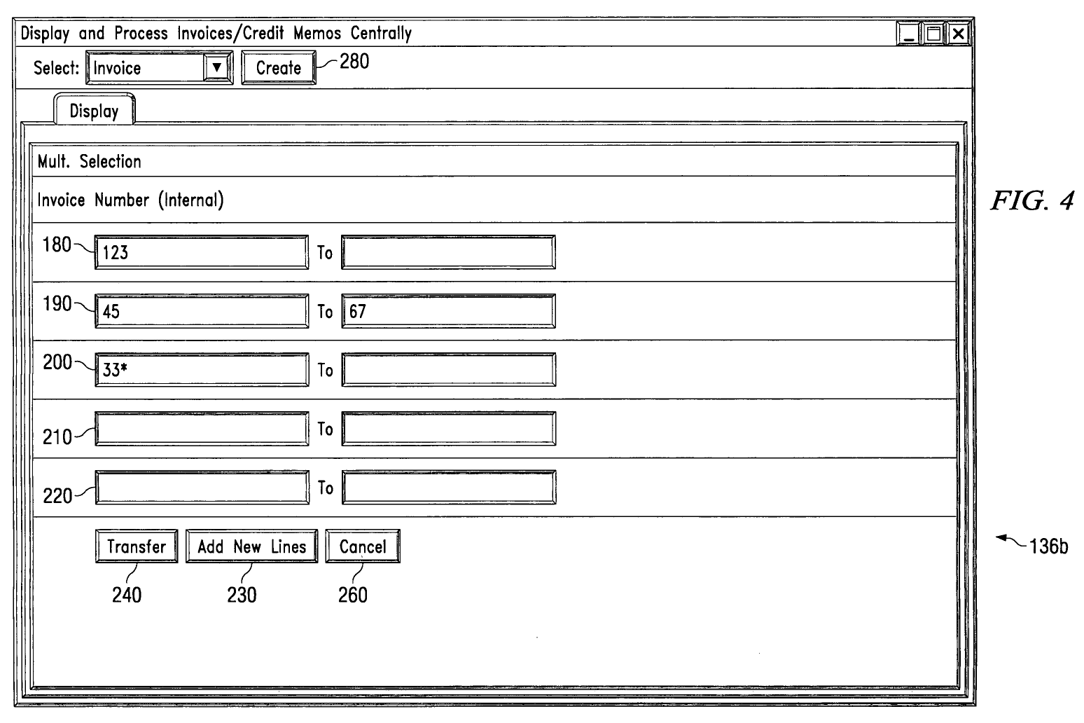

Upon the arrow icon button 145 being selected or otherwise activated, a GUI 136b appears, as illustrated in FIG. 4. GUI 136b (hereinafter referred to as “multiple values screen”) is a graphical representation of a search table defined by a search string having multiple search values. However, the search table may be defined partly or entirely by the values inputted into the rows of field of multiple values screen, as described below.

In the multiple values screen, the search string is divided up into its individual search terms, and the search terms are placed in separate fields provided on separate rows of the multiple values screen, for example. The multiple values screen allows a user to, among other things, clearly identify the different search terms included in a search string and input, modify, or delete one or more search values separately rather than within a single search string.

If a search string has previously been inputted into the corresponding search criteria field of the search screen, the multiple values screen is populated with the different search values or range of values. As shown in FIG. 4 and corresponding to the example described above, the first search value, “123,” is listed in the first row of fields 180; the range 45 to 67 is listed in a second row of fields 190; and the third search value, “33*,” is provided in the third row of fields 200. Search field rows 210 and 220 are blank. The values in each of the three rows 180 through 200 may be edited by the user in the multiple values screen. Also, one or more of the search values may be deleted, or one or more additional search values may be added in the multiple values screen. For example, additional search terms may be added in the vacant search fields of rows 210 and 220. Although FIG. 3 shows the multiple values screen as having only five rows of search fields, other implementations may have a greater or fewer number of search field rows. Moreover, referring to the present example, if the user desires to add additional search terms in excess of five, the user may select the Add New Lines button 230. When the Add New Lines button 230 is selected, one or more additional rows of search fields may be added so that additional search values or ranges of values may be included. Accordingly, the terms of a search string may be inputted, modified, or deleted from either the search screen or the multiple values screen. Moreover, a change, addition, or deletion made in the search screen or the multiple values screen is automatically updated and reflected in the other of the search screen or the multiple values screen.

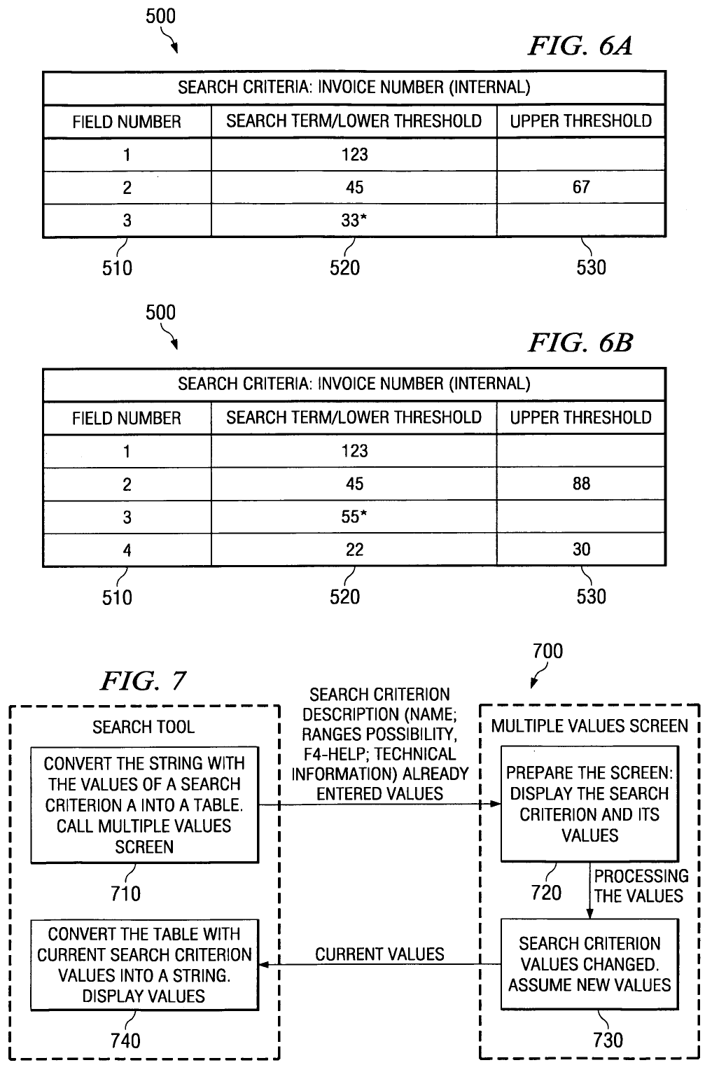

An example search table 500 corresponding to the Invoice Number (Internal) search criteria shown in FIG. 3 is illustrated in FIG. 6A. FIG. 6A is merely one possible example of a search table within the scope of the present disclosure. In the illustrated example, the search table includes a field number column 510 designating each search term. The search table also includes a column 520 designating a lower threshold of a search range or an individual search value. Further, the search table 500 also includes an upper range column 530, indicating an upper threshold of a search range.

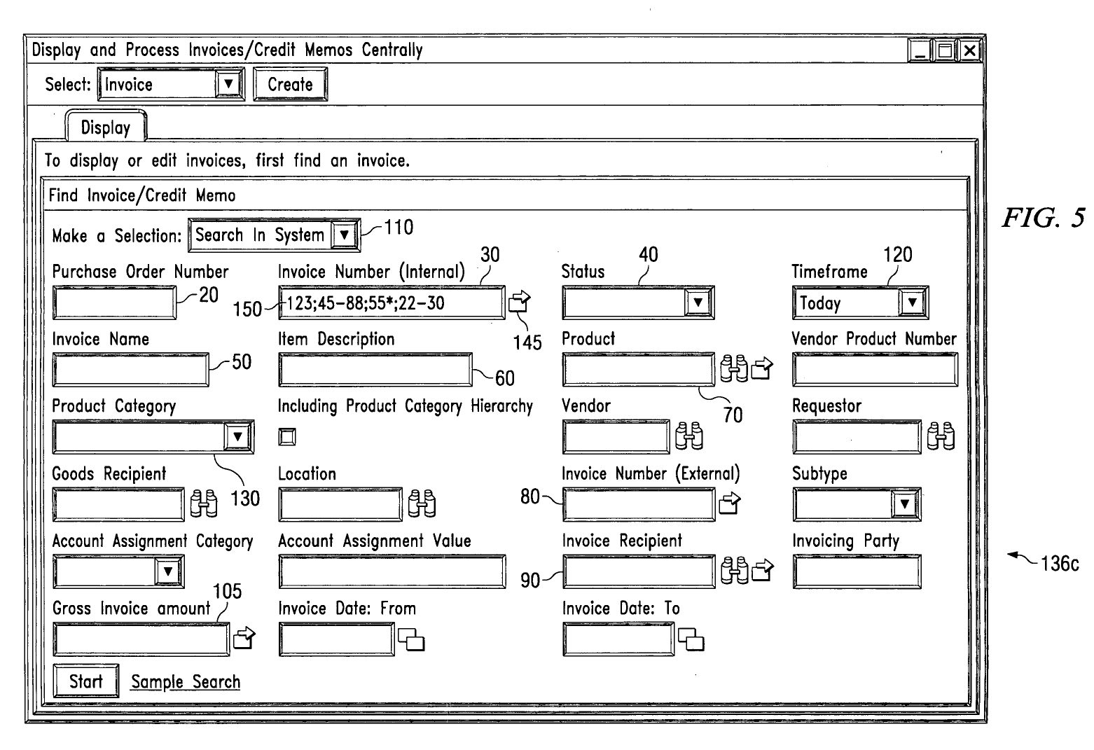

For example, the search range of 45 to 67 may be changed to a range of 45 to 88. Also, the search term “33*” may be amended to be “55*,” and an additional search range may be defined, such as 22 to 30. Once these or any other changes are made, the user may select the Transfer button 240. The Transfer button 240 switches back to the search screen (GUI 136c), as shown in FIG. 5, and the search terms may be recombined into a single search string. Alternately, the user may select the Cancel button 260 to cancel any changes that may have been made to the search terms. Further, a new multiple values screen for a different search criteria (e.g., Invoice Number (External), Gross Invoice Amount, etc.) may be selected directly from the multiple values screen of a different search criteria by selecting the desired field from the Select box 270 (shown in FIG. 4). The user may select the desired search criteria from a pull-down menu. Once a desired search criteria has been selected, the user may select the Create button 280. Once the Create button 280 has been selected, a new multiple values screen is displayed corresponding to the selected search criteria. The user may input search values in the manner described above

Once the Transfer button 240 is selected, as explained above, any changes or additions made in the multiple values screen may be automatically reflected in the search screen. Therefore, as shown in FIG. 5, the search string in the Invoice Number (Internal) field 30 reflects the changes made in the multiple values screen, described above. That is, the search range of 45 to 67 has been changed to 45 to 88, the search value “33*” has been changed to “55*,” and the new search range 20 to 33 is now present. The search field 30 may be further amended or additional search strings may be added or amended to other search criteria fields provided. Any modification to the search terms may be updated automatically in the search table. For example, as shown in FIG. 6B, the modifications made to the search terms of the multiple values screen of FIG. 5 are reflected in the corresponding search table 500.

A search string may or may not be entered into a search criteria field of the search screen prior to selecting the arrow icon button 145 corresponding to the search criteria field. If a search string has not previously been inputted into a search criteria field of the search screen and the user selects the arrow icon button 145 corresponding to the particular search criteria field, the fields in the resulting multiple values screen will be empty. The user may then input one or more search values into corresponding fields. Referring to FIG. 4, for example, if the arrow icon button 145 were selected for the Invoice Number (Internal) field 30 before a search string were inputted therein, the multiple values screen would not include any search terms in any of the rows 180-220. A user could then input one or more search values into the available rows of fields 180-220 or any additional rows of fields added by selecting the Add New Lines button 230.

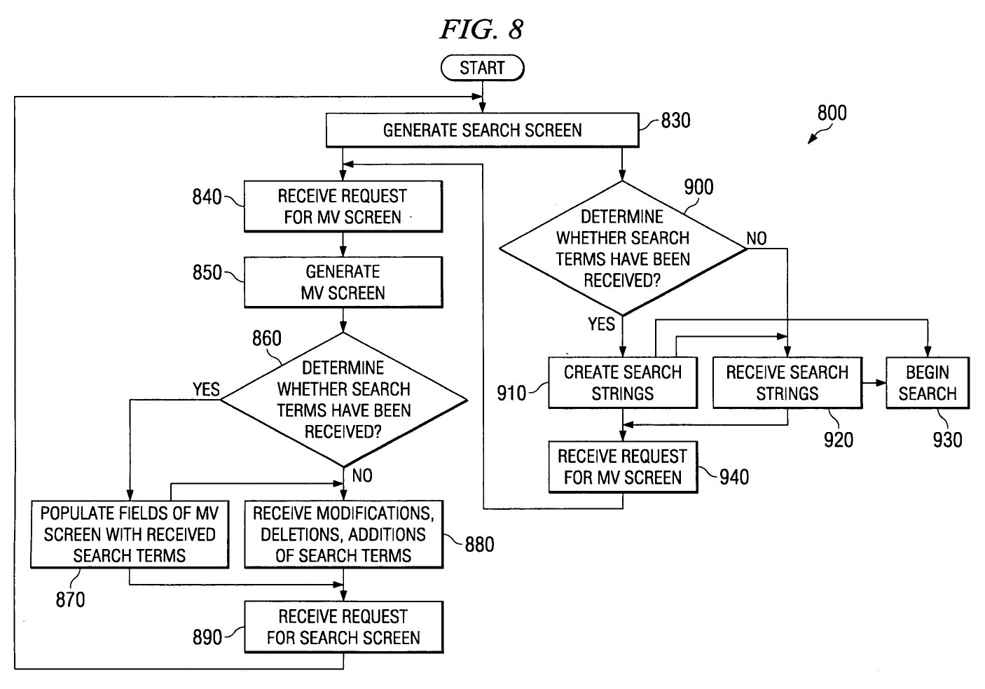

FIG. 7 is a flow chart diagrammatically illustrating a multiple value search method 700 according to the present disclosure. FIG. 7 illustrates, among other things, how changes to a search string made in one of the search screen or the multiple values screen are automatically updated to the other of the corresponding search screen or the multiple values screen for any given search criteria. At 710, one or more search strings having one or more search terms are inputted into one or more fields provided on the search screen. A search table for each search string is created utilizing the associated search terms. At 720, the fields of a multiple values screen corresponding to a particular search criteria are populated with the search terms of the related search string. The user may switch from the search screen to the multiple values screen by selecting the arrow icon button 145, for example, as explained above. At 730, the search terms in the fields may be changed, such as by adding, deleting, or modifying the search terms in the multiple values screen. At 740, when the user switches back to the search screen, the modified terms are recombined into a search string and placed in the field corresponding to the appropriate search criteria. Again, the user may switch from the multiple values screen to the search screen by selecting the Transfer button 240.

Once the user has completely defined a search by inputting a search string into the desired search criteria field(s), the user may select the Start button 250 to begin the search and to retrieve the data satisfying the defined search criteria. During the search, the method and system may identify any and all data satisfying the defined search criteria for each value or values defined in the criteria search string(s). Although the search screen in FIG. 3 is shown as having search strings in only three search fields (i.e., Invoice Number (Internal) field 30, System Search field 110, and the Timeframe field 120), more or fewer of the search fields may be used to modify the search parameters.

According to one or more implementations, the multiple value search method and system of the present disclosure is operable with multiple modules. Thus, the multiple value search method and system is able to search data of multiple modules simultaneously, for example, with a defined search having one or more multiple value search criteria. For example, the present system is able to search one or more data repositories of separate modules with all of the defined search strings of a defined search or utilize only a portion of the search strings to search one or more modules and only a portion of the search strings to search a separate module or modules. Alternately, all of the search strings may be utilized in searching the data of one or more modules while only a portion of the search strings may be utilized in searching the data of a separate module or modules. The output of such a search may be consolidated into a single search report or may be classified by the data type or module from which the data was retrieved. However, the multiple value search method and system of the present disclosure is not so limited, and the search report may be organized in any fashion.

FIG. 8 illustrates a flow diagram illustrating an operating method 800 according to an implementation of the present disclosure. At 830, a search screen, such as the search screen illustrated in FIG. 3, is generated. Thereafter, the user may input search strings into one or more search criteria fields, as described above, or the user may request a multiple value screen corresponding to a particular search criteria, such as multiple values screen, described above. The user may select the multiple value screen by selecting a button associated with the search criteria, for example. At 840, a multiple value screen corresponding to the particular search criteria is requested. The multiple value screen is generated at 850. At 860, it is determined whether one or more search terms have been inputted for the particular search criteria. At 870, if it is determined that one or more search terms have been inputted, one or more fields of the multiple value screen is populated with the one or more search terms. If no search terms have been inputted, the fields of the multiple value screen remain empty. At 880, the user may input one or more additional search terms, delete one or more search terms, or modify one or more search terms. At 890, a request for the search screen is received, such as when the user selects a button to transfer back to the search screen, and the search screen is again generated at 830. Alternately, at 890, a request for the search screen may be received immediately after 870. At 900, it is determined whether one or more search terms have been received. At 910, if one or more search terms have been inputted, a search string is generated for each search criteria for which the search terms have been inputted. At 920, one or more search strings are received, and, at 930, a request to begin the defined search is received. Further, after any of steps 900, 910, or 920, a request for a multiple value screen may be received at 940, causing a return to step 840. A search utilizing the received search terms may be executed at 930. The flow diagram shown in FIG. 7 is provided merely as an example, and it will be understood that numerous modifications thereto may be made without departing from the scope of the present disclosure. For example, a request may be received from the multiple value screen to proceed directly to a multiple value screen corresponding to different search criteria.

In one implementation, the multiple value search method and system described above may be generic and operable with any number of different applications. Other implementations may include an analysis functionality to aid a user in identifying an unrecognized or rejected search value. For example, a business application, utilizing the method and system for searching described above, may include a data repository of invoice numbers of a predetermined length, such as eight characters in length, for example. However, a user may input a search value having more or less than eight characters, which may otherwise result in an error or the return of a null set, i.e., no corresponding data. In such a situation, the analysis functionality may determine a reason for the error or null set, for example, in the present scenario, by determining that the search string was of a length that did not correspond to the data to be searched. Consequently, the analysis functionality may inform the user of the problem, such as with a message indicating the length, in number of characters, of the data corresponding to the search criteria. Such a message may aid the user in quickly determining the reasons for an error. Therefore, the analysis functionality is operable to analyze an inputted search value, compare the inputted search value with an expected search value type, and provide information to the user as to why the inputted value and the expected value type do not correspond. Moreover, the analysis functionality may be dynamic. That is, the analysis functionality may analyze the search terms of a particular criteria field as the terms are being inputted by a user to determine whether the search terms(s) is/are compatible with the data corresponding to the search criteria.

In another example, an expected search value may be all letter characters, whereas the inputted search value may contain one or more numerical characters. Consequently, the analysis functionality may inform the user that the inputted search value is invalid because the value contains unexpected characters, i.e., the one or more numerical characters.

Because the method and system of searching utilizing multiple values for one or more search criteria may be applied to or incorporated with any number of applications, the analysis functionality may be customizable or may be automatically capable of determining the type of expected input for a given search criteria. Consequently, the method and system for searching described may be easily incorporated into numerous applications.

The analysis functionality may also inform a user of which search criteria is utilized to search the data of a particular module. For example, the method and system for searching, described herein, may be utilized to search different modules having different data types. Consequently, some search criteria of a defined search may only be applicable to the data of one or more modules while other search criteria may only be applicable to one or more other modules. As a result, the analysis functionality may display or otherwise identify to the user which search criteria was used with which modules.

The preceding flowcharts and accompanying description illustrate exemplary methods 700 and 800. System 100 contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, system 100 may use methods with additional steps, fewer steps, and/or different steps, so long as the methods remain appropriate.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for utilizing multiple values of a search criteria, the method comprising:
receiving a search string corresponding to at least one search criteria via a search interface, wherein the search string comprises one or more search terms;
generating a search table for one or more search criteria based on the one or more search terms;
performing a search of at least one data repository using the search table; and
returning at least a portion of the search results satisfying the search terms to the search interface.

2. The method according to claim 1 further comprising:
receiving a request for a multiple value screen;
populating the multiple value screen with the one or more search terms corresponding to the search criteria;
receiving a modification of the search terms; and
automatically updating the search table based on the modified search terms.

3. The method according to claim 2, wherein the modification of the search terms comprises at least one of an addition of one or more search terms, an amendment of one or more of the search terms, or a deletion of one or more of the search terms.

4. The method according to claim 2 further comprising:
receiving a request for the search screen; and
updating the search string with the at least one of the amendment, deletion, or addition.

5. The method according to claim 1, wherein the search interface is connected to multiple modules, wherein each module has a data repository, and wherein performing a search of the at least one data repository using the search table comprises performing a search of the data repository of each module.

6. Software for utilizing multiple values of a search criteria, the software comprising machine-readable instructions operable when executed to:
receive a search string corresponding to at least one search criteria via a search interface, wherein the search string comprises one or more search terms;
generate a search table for one or more search criteria based on the one or more search terms;
perform a search of at least one data repository using the search table; and
return at least a portion of the search results satisfying the search terms to the search interface.

7. The software according to claim 6 further comprising machine-readable instructions operable when executed to:
receive a request for a multiple value screen;
populate the multiple value screen with the one or more search terms corresponding to the search criteria;
receive a modification of the search terms; and
automatically update the search table based on the modified search terms.

8. The software according to claim 7, wherein the modification of the search terms comprises at least one of an addition of one or more search terms, an amendment of one or more of the search terms, or a deletion of one or more of the search terms.

9. The software according to claim 5 further comprising machine-readable instructions operable when executed to:
receive a request for the search screen; and
update the search string with the at least one of the amendment, deletion, or addition.

10. The software according to claim 6, wherein the interface is connected to multiple modules, wherein each module has a data repository, and wherein the machine-readable instructions operable when executed to perform a search of the at least one data repository using the search table comprises performing a search of the data repository of each module.

11. A system for utilizing multiple values of a search criteria, the system comprising:
means for generating a search screen including at least one search criteria;
means for receiving a search string corresponding to the at least one search criteria, wherein the search string comprises one or more search terms;
means for defining a search table for the at least one search criteria, the search table comprising the one or more search terms;
means for performing a search of one or more data repositories utilizing each search term included in the search table; and
means for returning search results satisfying the search terms.

12. The system according to claim 11 further comprising:
means for receiving a request for a multiple value screen;
means for populating the multiple value screen with the one or more search terms corresponding to the search criteria;
means for receiving a modification of the search terms; and
means for automatically updating the search table based on the modified search terms.

13. The system according to claim 11, wherein the modification of the search terms comprises at least one of an addition of one or more search terms, an amendment of one or more of the search terms, or a deletion of one or more of the search terms.

14. The system according to claim 13 further comprising:
means for receiving a request for the search screen; and
means for updating the search string with the at least one of the amendment, deletion, or addition.

15. The system according to claim 11, wherein the search interface is connected to multiple modules, wherein each module has a data repository, and wherein means for performing a search of the at least one data repository using the search table is operable to perform a search of the data repository of each module.
